(19) United States
(12) Patent Application Publication
(10) Pub. No.: US 2023/0100010 A1
(43) Pub. Date: Mar. 30, 2023

(54) ROTARY SUSPENSION STOP PROVIDED WITH A SHRINK-FIT SEAL AND RETAINER

(71) Applicant: NTN-SNR ROULEMENTS, Annecy (FR)

(72) Inventors: Alexandre BAUDU, Annecy (FR); Aurélien BONNAUDET, Annecy (FR); Anthony CAMPART, Marcellaz-Albanais (FR); Vincent POURROY-SOLARI, Thones (FR)

(73) Assignee: NTN-SNR ROULEMENTS, Annecy (FR)

(21) Appl. No.: 17/935,583

(22) Filed: Sep. 27, 2022

(30) Foreign Application Priority Data
Sep. 30, 2021 (FR) 2110338

(51) Int. Cl. B60G 15/06; F16C 17/10; F16C 33/78; F16C 33/74

(52) U.S. Cl. CPC B60G 15/063; F16C 17/10; F16C 33/7823; F16C 33/74; B60G 2204/418; F16C 2326/05

(57) ABSTRACT

A rotary suspension stop for a suspension strut comprises a bearing, a lower support forming a bearing surface for an upper turn of a helical spring and an annular shrink-fitting surface turned radially in a radial reference direction, a cover comprising an annular skirt extending axially facing and at a distance from the shrink-fitting surface and a seal having a body, at least one annular sealing lip in sliding contact against the annular skirt of the cover and at least a first set of one or more elastic first shrink-fit lips projecting toward the shrink-fitting surface and shrunk to the shrink-fitting surface.

### CROSS-REFERENCE TO RELATED APPLICATIONS

This application claims priority to French Patent Application No. 2110338, filed Sep. 30, 2021; the disclosure of which is incorporated herein by reference in its entirety.

### FIELD

The disclosure relates to a rotary suspension stop for interfacing an upper turn of a vehicle suspension helical spring with the body of the vehicle.

### BACKGROUND

Document EP 3626486 A1 describes a rotary suspension stop for a suspension strut, comprising a lower support forming a bearing surface for an upper turn of a helical spring, a bearing supported by the lower support and a cover forming, with the lower support, a housing for the bearing. An annular seal is shrunk onto the cover and has sealing lips that come into sliding contact with the lower support to create a protective seal for the housing where the bearing is located. This seal also has a heel that projects radially into an annular groove formed in the lower support to guarantee cohesion between the cover and the lower support before mounting the rotary stop on the vehicle. This solution is suitable for a lower support made of molded material with movable mold parts in a radial plane relative to the axis of revolution of the rotary stop. If the lower support is made by an axial casting method, it is necessary to machine the annular groove, which is not acceptable from an economic point of view. Furthermore, in the event that the lower support is made of metallic material, it is necessary to provide a particular finish for the sliding contact surface with the sealing lip.

A suspension stop whose lower support is made of axially molded metallic material is disclosed in document WO 2021/018837. To allow attachment between the cover and the lower support of this rotary stop, it is proposed in this document to shrink the lower washer of the roller bearing in the lower support, and to provide a flange on this lower washer that is positioned in a groove formed in the cover. This solution, which does not include the sealing function but only the function of maintaining the cohesion of the rotary stop before it is mounted on the vehicle, has the disadvantage of requiring tight tolerances and of generating significant stresses at the shrinking interface between the lower washer of the bearing and the lower support. To perform the sealing function, it is recommended, in document FR 3101279 A1, to overmold or to shrink, on the lower support, a seal having a sealing lip coming into sliding contact with the cover. The overmolding or molding of such a seal, however, requires complex shapes.

Document EP 3693625 A1 presents a rotary suspension stop equipped with a seal and retainer, comprising a seal body fixed to the lower support in an unspecified manner, and a lip that comes into sliding contact with a cylindrical wall of the cover to perform a sealing function, the cover being provided at the end of the cylindrical wall with a bead in radial overlap with the lip to ensure the axial retention between the cover and the lower support. The seal body is in surface contact with the lower support along a cylindrical interface and a planar annular interface. One solution for securing the seal to the lower support is overmolding, as described for example in document FR 2989634 A1. An alternative theoretical solution would be shrinking, but this requires very tight manufacturing tolerances at the cylindrical wall of the lower support in contact with the seal body to prevent defects in the cylindricity of the cylindrical wall from affecting the sealing lip through the seal body and thus deteriorate the sealing performance or the lifetime of the lip. This solution would also require rigid reinforcement at the seal to ensure controlled shrinking due to the small section of the seal and the low height available for shrinking.

Also known from document WO 11103921 A1 is a rotary suspension stop having a seal mounted movably both relative to the lower support and to the cover, this seal having retaining means projecting radially toward the cover and toward the lower support to retain the cover axially relative to the lower support. However, the quality of the produced sealing is not satisfactory.

### SUMMARY

The disclosure aims to remedy the drawbacks of the state of the art and to propose a solution for achieving sealing, and preferably axial retention, between a cover and a lower support of a rotary suspension stop, which can be used in particular with a lower support whose manufacturing tolerances are imprecise, and is compatible with an axial molding of the lower support.

To do this is proposed, according to a first aspect of the disclosure, a rotary suspension stop for a suspension strut, the rotary suspension stop comprising:
a bearing defining a reference axis and an upward axial direction of the rotary stop,
a lower support forming a bearing surface turned axially opposite the upward axial direction to bear against an upper turn of the helical spring, and an annular shrink-fitting surface turned radially in a radial reference direction,
a cover forming, with the lower support, an annular volume for the bearing, the cover comprising an annular skirt extending axially facing and at a distance from the shrink-fitting surface,
a seal, mounted on the shrink-fitting surface of the lower support, having a body and at least one annular sealing lip projecting from the body in the radial reference direction, toward the annular skirt, the seal having at least a first set of one or more first elastic shrink-fit lips projecting from the body toward the shrink-fitting surface and shrinking on the shrink-fitting surface.

The area of the contact surface between the first shrink-fit lip(s) and the shrink-fitting surface is relatively small—substantially smaller than the surface area of the seal body facing the shrink-fitting surface—which allows a high contact pressure to be obtained without, however, requiring a significant effort to assemble. The elasticity of the first shrink-fit lip(s) makes it possible to obtain a controlled shrinking pressure even if the manufacturing tolerances concerning the shrink-fitting surface are significant. The seal body that is interposed between the first shrink-fit lip(s) and the sealing lip makes it possible to limit the incidence of cylindricity defects of the shrink-fitting surface on the sliding contact between the sealing lip and the skirt.

Preferably, the first shrink-fit lip(s) protrude from a junction zone with the body, located axially at a distance from a junction zone of the sealing lip with the body, preferably in an axial direction opposite the upward axial direction. The axial distance between the junction zone of the sealing lip and the junction zone of the first shrink-fit lip(s) makes it possible to increase the elastic deformation capacity of the seal body to absorb the defects of the shrink-fitting surface by limiting their impact on the sealing lip.

Preferably, the first shrink-fit lip(s) protrude from the body radially in a radial direction opposite the reference radial direction and axially in the upward direction. The orientation of the shrink-fit lip(s) of the first set facilitates their assembly by forcible insertion of the seal on the lower support in the direction opposite to the upward direction, and opposes the shrinkage of the seal in the upward axial direction.

According to a particularly high-performance embodiment, the first shrink-fit lip(s) have a free end forming, in axial section, a vertex with a sharp angle greater than 20°, preferably greater than 70° and less than 90°, preferably less than 80°, the vertex having, in axial section, a bisector forming an angle preferably greater than 10°, preferably greater than 30° with the upward axial direction. These shapes make it possible to increase the resistance of the seal to shrinkage in the upward axial direction.

According to a particularly advantageous embodiment, the cover comprises at least one retaining stop projecting from the annular skirt in a radial direction opposite the reference radial direction, the sealing lip being partly in radial overlap with the retaining stop, away from the retaining stop in the upward axial direction. The seal then performs the function of sealing and retaining the cover before mounting the rotary stop on the vehicle.

According to one embodiment, the sealing lip has a V-shaped axial section, with a vertex of the V pointing in the upward axial direction. This shape ensures good flexibility of the sealing lip and good control of the contact pressure with the annular skirt, and therefore of the drag torque resisting the relative rotation of the lower support with respect to the cover about the reference axis of the rotary stop.

According to one embodiment, the body has two opposite axial end faces, preferably annular, preferably radially overlapping with each other. These arrangements allow the seals to be stacked during their manufacture, transport and handling, and before they are mounted on rotary stops.

According to one embodiment, the sealing lip is located axially entirely between the two opposite axial ends of the body. In the event of significant deformation, for example during assembly or in extreme usage conditions, the sealing lip comes into contact with the seal body, on which it can rest without risk of damage.

The disclosure is particularly suitable for a suspension stop, the lower support of which is a single piece of light metallic material. In particular, the lower support can be manufactured by axial molding, that is to say, between two mold parts separating by translation parallel to the reference axis of the rotary stop, without requiring lateral slide valves for undercut shapes. According to one embodiment, the shrink-fitting surface has a cylindrical or substantially cylindrical envelope. Here, “substantially cylindrical” means a surface that, within manufacturing tolerances, has a clearance angle of less than 3°, to allow axial demolding of the lower support without degrading the shrinking zone of the seal.

According to one embodiment, the shrink-fitting surface is positioned, with reference to the upward axial direction, axially above the bearing surface.

According to one embodiment, the first set of one or more first shrink-fit lip(s) consists of a first annular elastic shrink-fit lip.

According to an alternative embodiment, the first set of one or more first shrink-fit lip(s) consists of a row of N first lips having a symmetry of revolution of order N about the reference axis, where N is a whole number greater than or equal to 2, and preferably greater than or equal to 3.

In certain configurations, control of the deformation of the seal body during shrinking may require shrink-fit lips located in several planes perpendicular to the reference axis. Thus, according to one embodiment, the seal comprises at least one second set of one or more second shrink-fit lips, located axially at a distance from the first shrink-fit lip(s) of the first set. Preferably, the sealing lip has an annular zone of sliding or uncertain contact with the annular skirt of the cover, located axially between a zone of shrink-fit contact between the first shrink-fit lip(s) and the shrink-fitting surface and a zone of shrink-fit contact between the second shrink-fit lip(s) and the shrink-fitting surface. According to an embodiment allowing the seal to be molded without undercut, the first set consists of several first shrink-fit lips distributed over the same first circumference of the seal, the second set consists of several second shrink-fit lips distributed over a same second circumference of the seal, and the second shrink-fit lips do not overlap with the first shrink-fit lips.

According to one embodiment, the lower support comprises an annular transition face extending radially from the shrink-fitting surface in the radial reference direction and axially turned in the upward direction, the seal preferably being in sealed annular bearing against the transition face, preferably by a static sealing lip or a static sealing heel. The annular bearing constitutes a static seal that completes the dynamic sealing between the sealing lip and the annular skirt of the cover in order to protect the annular volume for the bearing between the lower support and the cover.

According to one embodiment, the sealing lip is in sliding contact with the annular skirt. Alternatively, the seal may be without contact with the annular skirt, the sealing being achieved by the partial closing of the space between the shrink-fitting surface of the lower support and the annular skirt of the cover. If necessary, in the event that the annular skirt is provided with a retaining stop, preferably annular, the latter can constitute, with the projecting lip with or without contact of the seal, a baffle contributing to the sealing.

According to one embodiment, the radial reference direction is turned radially outward, the skirt preferably being positioned radially outside the bearing.

According to one embodiment, the radial reference direction is turned radially inward, the skirt preferably being positioned radially inside the bearing.

According to one embodiment, the bearing comprises an annular upper guide path fixed relative to the cover, an annular lower guide path fixed relative to the lower support, arranged opposite the upper guide path, and means interposed between the upper guide path and the lower guide path to allow rotation of the lower guide path relative to the upper guide path about the reference axis of the rotary stop. These means may for example include a lubricant film or an annular pad in sliding contact with the upper guide path and the lower guide path in the case of a plain bearing, or rolling bodies, if necessary housed in a cage, and rolling on the upper guide path and the lower guide path, in the case of a roller bearing. The upper guide path can be formed in one piece with the cover or on a guide washer bearing on the cover. The lower guide path can be formed in one piece with the lower support or on a guide washer bearing on the lower support.

Preferably, the seal and retainer is made of synthetic material, preferably plastic, in particular polyketone (PK), or polyoxymethylene (POM), preferably without reinforcement.

### BRIEF DESCRIPTION OF THE FIGURES

Other features and advantages of the disclosure will emerge on reading the following disclosure, with reference to the appended figures.

FIG. 1 illustrates, in axial half-section, a rotary suspension stop according to a first embodiment of the disclosure.

FIG. 2 illustrates, in perspective, a detail of an outer seal and retainer of the stop of FIG. 1.

FIG. 3 illustrates, in perspective, a detail of an inner seal of the stop of FIG. 1.

FIG. 4 illustrates, in axial half-section, a rotary suspension stop according to a second embodiment of the disclosure.

FIG. 5 illustrates, in perspective, a detail of a seal and retainer of the stop of FIG. 4.

FIG. 6 illustrates, in axial section, a detail of a rotary suspension stop according to a third embodiment of the disclosure.

FIG. 7 illustrates, in perspective, a detail of a seal and retainer of the stop of FIG. 6.

FIG. 8 illustrates, in perspective, a detail of a seal and retainer in a variant of FIG. 7.

For greater clarity, identical or similar elements are identified by identical reference signs in all of the figures.

### DETAILED DESCRIPTION

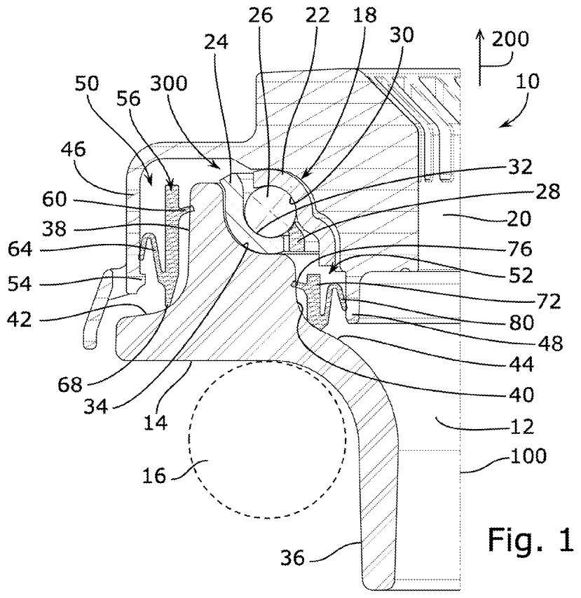

FIG. 1 illustrates a rotary stop 10 for a vehicle suspension strut, comprising a lower support 12 forming a bearing surface 14 for an upper turn 16 of a helical spring, a bearing 18 supported by the lower support 12 and a cover 20 forming, with the lower support 12, a housing volume 300 for the bearing 18.

In this example, and non-limitingly, the bearing 18 has been illustrated as a roller bearing comprising an upper washer 22 bearing under the cover 20, a lower washer 24 bearing on the lower support 12 and rolling bodies 26 retained by a rolling cage 28 so as to roll on an upper guide path 30 formed on the upper washer 22 and a lower guide path 32 formed on the lower washer 24. The bearing 18 allows a relative rotational movement between the upper guide path 30 and the lower guide path 32, therefore between the cover 20 and the lower support 12, about an axis of revolution 100 of the bearing 18, which constitutes a reference axis of the rotary stop 10. The bearing 18 also defines an upward direction 200 parallel to the reference axis 100 and such that the bearing surface 14 of the lower support 12 is located under the bearing 18, which in turn is located under the cover 20. After mounting on the vehicle, the reference axis 100 of the rotary stop 10 can be vertical or inclined.

The lower washer 24 bears against a bearing face 34 of the lower support 12 facing axially in the upward direction and which, in this embodiment, is positioned radially overlapping with the bearing surface 14 formed on the lower support 12 for the helical spring 16. The bearing surface 14 of the lower support 12 is turned axially opposite the upward axial direction 200, and is extended by a centering skirt 36 projecting axially downwards. The lower support 12 further comprises an annular outer shrink-fitting surface 38 facing radially outwards and located radially outside of the bearing face 34, as well as an inner shrink-fitting surface 40 annular facing radially toward the inside, located radially inside the bearing face 34. These two shrink-fitting surfaces 38, 40 are cylindrical or tapered with a clearance angle preferably less than 5° (converging in the upward direction for the outer shrink-fitting surface 38 and in the downward direction for the inner shrink-fitting surfaces 40). The outer shrink-fitting surface 38 is extended by an outer annular transition face 42 that extends from the outer shrink-fitting surface 38 radially outwards and faces axially in the upward direction 200. Similarly, the inner shrink-fitting surface 40 is extended by an inner annular transition face 44 that extends from the inner shrink-fitting surface 40 radially inward and faces axially in the upward direction 200.

The cover 20 comprises an annular outer skirt 46 facing and at a distance from the outer shrink-fitting surface 38 and an annular inner skirt 48 facing and at a distance from the inner shrink-fitting surface 40, so that an outer annular passage 50 is delimited for access to the housing volume 300 of the bearing 18 between the outer shrink-fitting surface 38 and the outer skirt 46, and an inner annular passage 52 for access to the housing volume 300 of the bearing 18 between the inner shrink-fitting surface 40 and the inner skirt 48. One of the two skirts 46, 48 of the cover 20, here the outer skirt 46, can be provided with one or more retaining stops projecting radially from the skirt toward the lower support, made here in the form of a bead 54 at the end of the outer skirt 46.

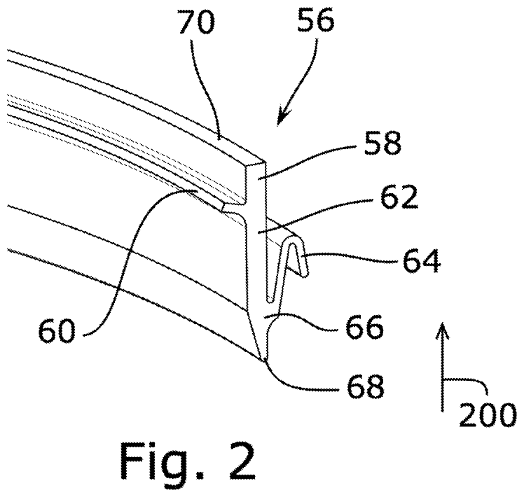

In the outer annular passage 50 a seal and retainer 56, hereinafter called outer seal, is engaged that is intended both to protect the bearing 18 against external pollution and to maintain the cohesion between the cover 20 and the lower support 12 before mounting the rotary stop 10 on the vehicle. In this embodiment, the outer seal 56, illustrated in detail in FIG. 2, is made of a single piece of synthetic material without insert, and comprises an annular body 58, an elastic shrink-fit lip 60 projecting from a junction zone 62 with the body 58 toward the outer shrink-fitting surface 38 of the lower support 12, a sealing lip 64 projecting from a junction zone 66 with the body 58 toward the outer skirt 46 of the cover 20, coming into sliding contact with the outer skirt 46 of the cover 20, and a heel 68 coming into elastic abutment against the outer annular transition face 42.

The elastic shrink-fit lip 60 here is annular, substantially frustoconical and in dimensional interference with the shrink-fitting surface 38, so as to be shrunk on the shrink-fitting surface 38 during the assembly of the rotary stop 10, before the cover 20 is fitted, by a forcible fitting movement in the downward direction on the shrink-fitting surface 38. To facilitate this fitting movement and oppose the extraction of the outer seal 56, the shrink-fit lip 60 protrudes from the outer seal body 56 both radially toward the outer shrink-fitting surface 38 and axially in the upward direction 200.

The sliding sealing lip 64 has an axial V-section, with a vertex of the V pointing in the upward axial direction 200, while the free end of the sealing lip 64, in contact with the outer skirt 46 of the cover, points in the downward axial direction, toward the stop formed by the bead 54 at the end of the outer skirt 46. This shape facilitates the assembly of the cover 20 by snap-fastening onto the assembly formed by the lower support 12, the bearing 18 and the outer seal 56, and allows an elastic attachment that opposes a separation of the cover 20 after assembly, and until assembly on the vehicle.

The junction zone 66 between the sealing and retaining lip 64 and the body 58 of the seal is located axially at a distance from the junction zone 62 between the shrink-fit lip 60 and the body 58 of the seal. Thus, the stresses induced in the material of the seal 56 by the deformation of the shrink-fit lip 60 following the shrinking on the shrink-fitting surface 38 are distributed in the body 58 of the seal and do not result in significant deformations at the sealing and retaining lip 64. In this first embodiment, the junction zone 66 between the sealing lip 64 and the body 58 of the seal is positioned, with reference to the upward direction 200, below the junction zone 62 between the shrink-fit lip 60 and the body 58 of the seal.

In this embodiment, the heel 68 is located at a lower end of the body 58 of the seal and constitutes a static seal with the lower support 12. The upper end 70 of the seal projects axially with respect to the sealing and shrink-fit lips 64, 60 so that the two lips 64, 60 are each located axially entirely between the two opposite axial ends 68, 70 of the body 58. This makes it possible to ensure that in the event of significant radial stresses on one or the other of the lips, during assembly or use, the lips 64, 60 come to bear against the body 58 of the seal in a controlled manner. Furthermore, the upper end 70 of the seal is radially overlapping with the heel 68, so that it is possible to stack several seals 56 before their assembly without risk of nesting, and without risk of contact of the lips 64, 60 of one seal with lips 64, 60 of an adjacent seal.

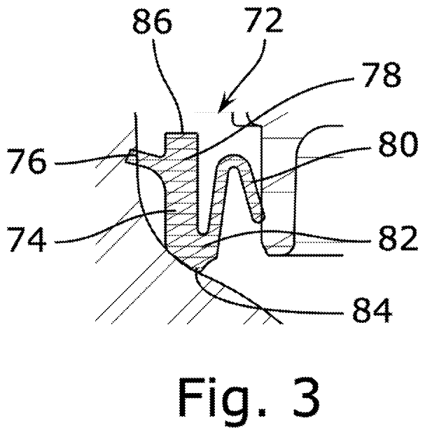

Furthermore, FIG. 3 provides a detailed illustration of a second seal 72, referred to below as the inner seal, located in the inner annular passage 52 delimited by the inner skirt 48 of the cover 20 and the inner shrink-fitting surface 40 of the lower support 12. This inner seal 72 has a structure similar to the outer seal 56 described previously, with a body 74, an elastic shrink-fit lip 76 projecting from a junction zone 78 with the body 74 toward the inner shrink-fitting surface 40 of the lower support 12 so as to be shrunk on the shrink-fitting surface 40, a sealing lip 80 projecting from a junction zone 82 with the body 78 toward the inner skirt 48 of the cover 20 to come into sliding contact with the inner skirt 48, and a heel 84 coming into elastic abutment against the inner annular transition face 44 to form a static seal therein. The junction zones 78, 82 of the two lips 76, 80 with the body 74 are spaced apart from each other and the two lips 76, 80 are located axially entirely between the axial ends 84, 86 of the body 74. In this embodiment, no retaining function has been given to the inner seal 72, but those skilled in the art will understand that as a variant, a bead can be provided at the lower end of the inner skirt 48, which bead projects radially toward the inner shrink-fitting surface 40, in order to achieve an elastic attachment of the cover 20 with respect to the sub-assembly constituted by the lower support 12 and the inner seal 72. Thus, depending on requirements, it is possible to perform the retaining function on only one of the two seals, outer 56 or inner 72, or on both.

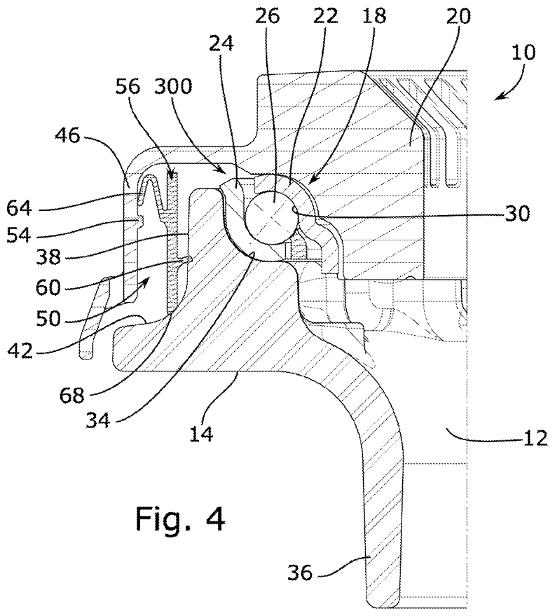

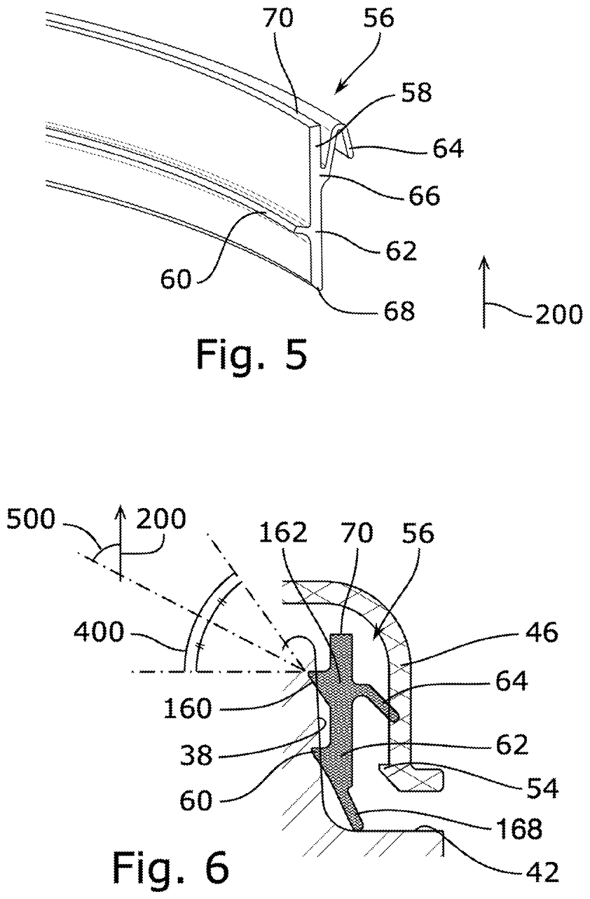

The embodiment of FIGS. 4 and 5 differs from the previous one on the one hand by the absence of an inner seal, and on the other hand by the structure of the outer seal 56, the junction zone 66 of which between the sealing lip 64 and the body 58 is positioned, with reference to the upward direction 200, at a distance above the junction zone 62 between the shrink-fit lip 60 and the body 56. The position of the bead 54 serving as a stop has also been shifted to maintain the desired clearance with the sealing and retaining lip 64.

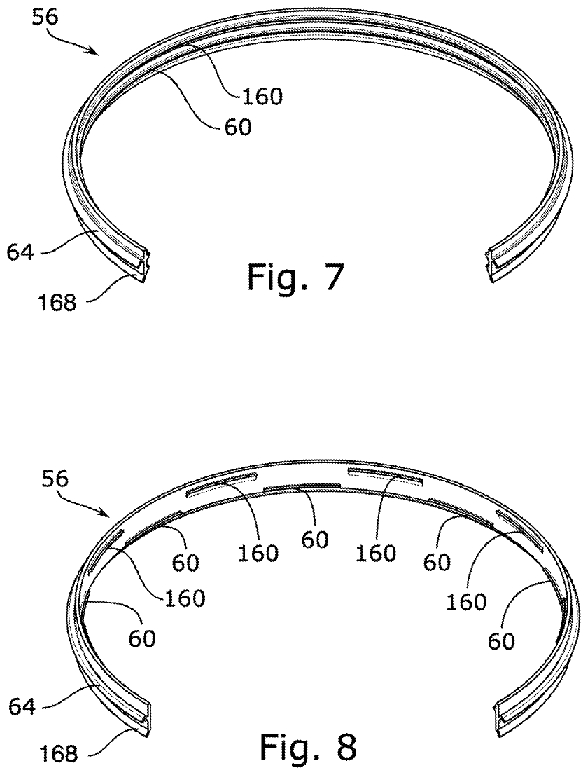

The embodiment of FIGS. 6 and 7 differs from the previous ones by the structure of the outer seal 56. There are variations in the shape of the sealing lip 64, which is substantially frustoconical, and the replacement of the static sealing heel by an elastic lip 168 resting against the annular transition face 42. Furthermore, the shrinking of the outer seal 56 on the outer shrink-fitting surface 38 is carried out by two annular shrink-fit lips 60, 160 arranged axially at a distance from one another.

As illustrated in detail in FIG. 6, each of the two shrink-fit lips 60, 160 has a free end forming, in axial section and before shrinking on the shrink-fitting surface, a vertex with a sharp angle 400 greater than 20°, preferably greater than 70° and less than 90°, preferably less than 80°, the vertex having, in axial section, a bisector forming an angle 500 preferably greater than 10°, preferably greater than 30° with the upward axial direction 200.

A first of the two shrink-fit lips 60 has a junction zone 62 with the body 58 of the seal, which is located at a distance below the junction zone 66 of the sealing lip 64 with the body 58 of the seal. The free end of the sealing lip 64, in sliding or uncertain contact with the annular skirt 46 of the cover, is located axially between a shrink-fit contact zone between the first shrink-fit lip 60 and the shrink-fitting surface 38 and a shrink-fit contact zone between the second shrink-fit lip 160 and the shrink-fitting surface 38.

The seal thus obtained has excellent characteristics in terms of the mechanical strength of the shrinking. However, the molding of the seal in a mold whose parts are movable in translation parallel to the axis of revolution of the seal is hampered by the presence of undercut shapes.

The variant embodiment of FIG. 8 offers a solution to this problem by no longer providing two annular shrink-fit lips, but two sets of several shrink-fit lips, namely a first set constituting a first row of N first lips 60, where N is an integer greater than or equal to 2, and preferably greater than or equal to 3, this first row having a symmetry of revolution of order N about the reference axis, and a second set constituting a second row of N second lips 160, also having a symmetry of revolution of order N about the reference axis, and offset with respect to the first lips 60 so that there is no overlap between the first and the second lips, for example at an angle equal to 360°/(2N).

The examples shown in the figures and discussed above are provided for illustrative purposes only. Other embodiments can be envisaged, in particular by combining the features of the various embodiments illustrated. Provision may in particular be made to replace the annular shrink-fit lip 60, 76 of the embodiments of FIGS. 1 to 5 with a set of shrink-fit lips constituting a row similar to what is illustrated in FIG. 8. The shrink-fit lip profile 60, 160 illustrated in FIG. 6 can be adopted for all the embodiments. What is described for a seal and retainer can be adapted to a seal having only the sealing function. The seal 56, 72 can be in permanent sliding contact with the associated annular skirt 46, 48, or in intermittent sliding contact, depending on the magnitude and direction of the forces applied to the rotary suspension stop. It can also be envisaged for the seal 56, 72 not to be in sliding contact with the associated annular skirt 46, 48 under normal operating conditions, sealing being ensured in this case by the labyrinth formed between the skirt ring 46, 48 and the zone of the seal 56, 72 that faces it directly. What is described for an outer seal can be transposed to an inner seal and vice versa. Furthermore, the bearing 18 can be of any type, roller or plain, and the guide paths 30, 32 can be made on attached washers 22, 24 or directly on the cover 20 and the lower support 12. The annular bead 54 can be replaced by one or more stops projecting radially toward the shrink-fitting surface, these stops being distributed over the circumference of the relevant skirt 46, 48. To accentuate the mechanical decoupling between shrink-fit lip(s) 60, 160 and sealing lip 64, 80, it is possible to provide that the seal 56, 72 is provided with a rigid annular reinforcement, made from a material more stiff than the lips.

1. A rotary suspension stop for a suspension strut, the rotary suspension stop comprising:
a bearing defining a reference axis and an upward axial direction of the rotary suspension stop;
a lower support forming a bearing surface turned axially opposite the upward axial direction to bear against an upper turn of the helical spring, and an annular shrink-fitting surface turned radially in a radial reference direction;
a cover forming, with the lower support, an annular volume for the bearing, the cover comprising an annular skirt extending axially, facing and at a distance from the shrink-fitting surface; and
a seal, mounted on the shrink-fitting surface of the lower support, having a body and at least one annular sealing lip projecting from the body in the radial reference direction, toward the annular skirt,
wherein the seal has at least a first set of one or more first elastic shrink-fit lips projecting from the body toward the shrink-fitting surface and shrinking on the shrink-fitting surface.

2. The rotary suspension stop according to claim 1, wherein the one or more first shrink-fit lips protrude from a junction zone with the body, located axially at a distance from a junction zone of the sealing lip with the body.

3. The rotary suspension stop according to claim1, wherein the one or more first shrink-fit lips protrude from the body radially in a radial direction opposite the reference radial direction and axially in the upward direction.

4. The rotary suspension stop according to claim 1, wherein the one or more first shrink-fit lips have a free end forming, in axial section, a vertex with a sharp angle greater than 20° and less than 90°.

5. The rotary suspension stop according to claim 1, wherein the cover comprises at least one retaining stop projecting from the annular skirt in a radial direction opposite the reference radial direction, the sealing lip being partly in radial overlap with the retaining stop, away from the retaining stop in the upward axial direction.

6. The rotary suspension stop according to claim 1, wherein the sealing lip has a V-shaped axial section, with a vertex of the V pointing in the upward axial direction.

7. The rotary suspension stop according to claim 1, wherein the body has two opposite axial end faces, annular and radially overlap with each other.

8. The rotary suspension stop according to claim 7, wherein a sealing lip of the first set of one or more first shrink-fit lips is located axially entirely between the two opposite axial ends of the body.

9. The rotary suspension stop according to claim 1, wherein the lower support is a single piece of light metallic material.

10. The rotary suspension stop according to claim 1, wherein the shrink-fitting surface has a cylindrical or substantially cylindrical envelope.

11. The rotary suspension stop according to claim 1, wherein the first set of one or more first shrink-fit lips consists of a first annular elastic shrink-fit lip or of a row of N first lips having a symmetry of revolution of order N about the reference axis, where N is an integer greater than or equal to 2.

12. The rotary suspension stop according to claim 1, wherein the seal comprises at least one second set of one or more second shrink-fit lips, located axially at a distance from the one or more first shrink-fit lips of the first set.

13. The rotary suspension stop according to claim 12, wherein the sealing lip has an annular zone of sliding or uncertain contact with the annular skirt of the cover, located axially between a zone of shrink-fit contact between the one or more first shrink-fit lips and the shrink-fitting surface and a zone of shrink-fit contact between the one or more second shrink-fit lips and the shrink-fitting surface.

14. The rotary suspension stop according to claim 12, wherein the first set of one or more first shrink-fit lips consists of several first shrink-fit lips distributed over the same first circumference of the seal, the second set of one or more second shrink-fit lips consists of several second shrink-fit lips distributed over a same second circumference of the seal, and the second shrink-fit lips do not overlap with the first shrink-fit lips.

15. The rotary suspension stop according to claim 1, wherein the lower support comprises an annular transition face extending radially from the shrink-fitting surface in the radial reference direction and axially turned in the upward direction.

16. The rotary suspension stop according to claim 1, wherein the sealing lip is in sliding contact with the annular skirt.

17. The rotary suspension stop according to claim 1, wherein the radial reference direction is turned radially outward, the skirt being positioned radially outside the bearing.

18. The rotary suspension stop according to claim 1, wherein the radial reference direction is turned radially inward, the skirt being positioned radially inside the bearing.

19. The rotary suspension stop of claim 2, wherein the one or more first shrink-fit lips protrude from the junction zone with the body, in an axial direction opposite the upward axial direction.

20. The rotary suspension stop of claim 15, wherein the seal is in sealed annular bearing against the transition face.
